(19) United States
(12) Patent Application Publication
(10) Pub. No.: US 2009/0236188 A1
(43) Pub. Date: Sep. 24, 2009

(54) Disc Brake, in Particular for a Commercial Vehicle

(75) Inventors: Christian RAFFIN, Grasbrunn (DE); Kai Fischer, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Knorr-Bremse Systeme fuer Nutzfahrzeuge GmbH, Muenchen (DE)

(21) Appl. No.: 12/389,752

(22) Filed: Feb. 20, 2009

Related U.S. Application Data
(63) Continuation of application No. PCT/EP2007/007359, filed on Aug. 21, 2007.

(30) Foreign Application Priority Data
Aug. 22, 2006 (DE) 10 2006 039 298.1

(51) Int. Cl. F16D 55/225

(52) U.S. Cl. 188/73.31

(57) ABSTRACT

A disc brake, in particular for a commercial vehicle, includes a caliper which surrounds a brake disc, against which brake pads can be pressed on both sides during braking. A holding bracket is fastened to the caliper and bears against pad retaining springs acting on outer edges of the brake pads. The holding bracket bridges a mounting opening of the caliper transversely with respect to the rotational direction of the brake disc and is preferably fastened by way of one end to the caliper in a positively locking manner and held by way of its other end by a fastening element such that the fastening element is connected captively to the holding bracket and corresponds with a securing part of the caliper in the sense of a holding device.

### CROSS-REFERENCE TO RELATED APPLICATIONS

This application is a continuation of PCT International Application No. PCT/EP2007/007359, filed Aug. 21, 2007, which claims priority under 35 U.S.C. § 119 to German Patent Application No. DE 10 2006 039 298.1, filed Aug. 22, 2006, the entire disclosures of which are herein expressly incorporated by reference.

### BACKGROUND AND SUMMARY OF THE INVENTION

The invention relates to a disc brake, in particular for a commercial vehicle, which includes a holding bracket for holding brake pads of the disc brake.

A disc brake of this type is known, for example, from DE 86 15 015 U1. The holding bracket of this disc brake serves substantially as a bracing support for pad retaining springs, in this case leaf springs, which resiliently tension the brake pads and thus largely prevent the production of chatter noises, in addition to securing the brake pads radially.

For rapid installation or removal of the brake linings, the holding bracket is fastened detachably to the brake caliper, so that exchanging of a brake pad is possible without difficulty.

In order to install and remove the holding bracket using simple measures, the bracket is inserted at one end in a pocket-shaped receptacle of the brake caliper and, at the other end, is firmly connected to the brake caliper via a screw. The bracket is therefore arranged to bridge an assembly opening for the brake pads.

In this case, the pocket-shaped caliper receptacle is provided on the side of the caliper forming the outer side of the disc brake, which side is located opposite a brake application device arranged in the caliper, which forms the inner side of the disc brake, that is, the inner side being the side oriented towards the center of the vehicle. In this case, the pocket-shaped receptacle may be produced by machining or may be cast integrally with the caliper during manufacture.

As mentioned, at the other end, the holding bracket is screwed to the caliper, which, however, requires correspondingly complex and costly machining, for example drilling of a core-hole and subsequent tapping of the hole.

These work operations run counter to optimized manufacture, so that the product as a whole can be produced only at a correspondingly high cost.

This applies equally to a disc brake in which the pocket-shaped receptacle is provided on the side of the caliper forming the inner side of the brake. The fixing of the holding bracket on the opposite side, that is, so to speak, on the outside of the disc brake, is effected by use of a stud, a washer and a split-pin (cotter key), the stud being connected to the brake caliper in a form-fitting manner. This positive fit is established above the holding bracket which, in conjunction with the washer, is pressed down by the split-pin and fastened to the stud.

However, the stud/washer and split-pin connection requires a corresponding installation space, which can be achieved only with considerable complexity and cost as a result of the prevailing confined space conditions for installation of the disc brake in a wheel envelope.

Moreover, the machining of a bore in the caliper for receiving the stud must take place in a deviation from the main machining direction, whereby manufacture as a whole is made more difficult. In addition, the above-mentioned drilling and tapping of the core-hole in order to produce the screw connection can only be done in a deviation from the main machining direction, so that the same disadvantages are incurred here also.

Furthermore, with the known disc brakes there is, in principle, a danger that the fastening element will become detached and will be lost, in particular while driving, so that the holding bracket can no longer perform its function, with consequent failure of the disc brake.

It is, therefore, an object of the invention to develop a disc brake and a holding bracket such that they can be produced at lower cost and permit simpler and quicker installation and removal of the brake pads, while improving the overall operating safety of the disc brake.

This and other objects are achieved by a disc brake, in particular for a commercial vehicle, having a caliper which straddles a brake disc against which brake pads can be pressed on both sides during braking, and having a holding bracket fastened to the caliper and bearing against pad retaining springs which act on the outer edges of the brake pads. The holding bracket, which bridges an assembly opening of the caliper transversely to the direction of rotation of the brake disc is fastened at one end to the caliper in a preferably form-fitting manner and is retained at its other end by a fastening element, wherein the fastening element is connected non-detachably to the holding bracket and corresponds to a securing part of the caliper functioning as a holding device.

According to the invention, firstly, the overall operating safety of the disc brake is improved because the securing part is connected non-detachably, and therefore captively, to the rest of the holding bracket. Detachment of the fastening element, and therefore detachment of the holding bracket from its fastening position, is ruled out even with the continuous violent shaking caused by operation of the commercial vehicle. Because a disc brake is a safety-relevant component, the improvement of operating safety has special importance.

According to an advantageous configuration of the invention, the fastening element is connected integrally to the holding bracket and is configured in such a manner that, after installation, it can be moved by a simple mechanical operation to, so to speak, a locking position in which the fastening element bears without play against a securing part of the caliper, such that the holding bracket is secured against displacement in all directions.

In this case, the fastening element may be in the form of a locking tab which, after the holding bracket has been fitted onto the securing part of the caliper, is deformed, for example by pressing, so that it bears against the securing part.

As a result of the integral configuration of the fastening element with the holding bracket, especially simple and low-cost manufacture is possible, because the holding bracket is in the form of a punched part and can be formed from a sheet-metal strip.

In the case when the caliper is in the form of a casting, the securing part of the caliper, which is arranged on the side opposite the pocket-shaped receptacle and, according to the invention, corresponds to the fastening element in the sense of a holding device, is cast integrally with the caliper. In order to retain the holding bracket, the securing part has an undercut in which a web of the holding bracket located opposite the locking tab engages, which web delimits a through-opening which is formed in the corresponding end region of the holding bracket.

For simple installation of the holding bracket, including convenient bending or pressing of the locking tab, the securing part is preferably arranged in the region of the brake caliper which forms the outer side of the brake, that is, opposite to the brake-application device, so that problem-free access to the holding bracket, and to the connecting region, is also ensured for disassembly.

Apart from these practical advantages, the invention is distinguished by the fact that the fastening of the holding bracket requires very little installation space, and is thus highly compliant with the general requirements regarding space-utilization.

Furthermore, no special tools are required for installing or removing the holding bracket. This also contributes to simplified assembly.

The quasi-compression of the holding strap against the securing part prevents the production of clatter noises, since existing tolerances are compensated by the bending down, that is, pressing of the locking tab. This, so to speak, forcible compensation of tolerances also allows a manufacturing process which is more generous with regard to the tolerances to be respected, and thus inherently entails corresponding advantages.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a perspective view of a partial section of an inventive disc brake with a holding bracket that is not yet completely installed;

FIG. 2 shows the holding bracket according to FIG. 1, also in a perspective representation;

FIG. 3 shows the disc brake of FIG. 1 with a completely installed holding bracket, also as a partial section in perspective;

FIG. 4 shows a detail of the disc brake, viewed in the direction of the arrow IV in FIG. 1, in a sectional side view; and

FIG. 5 shows the detail on the disc brake, viewed in the direction of the arrow V in FIG. 3.

### DETAILED DESCRIPTION OF THE DRAWINGS

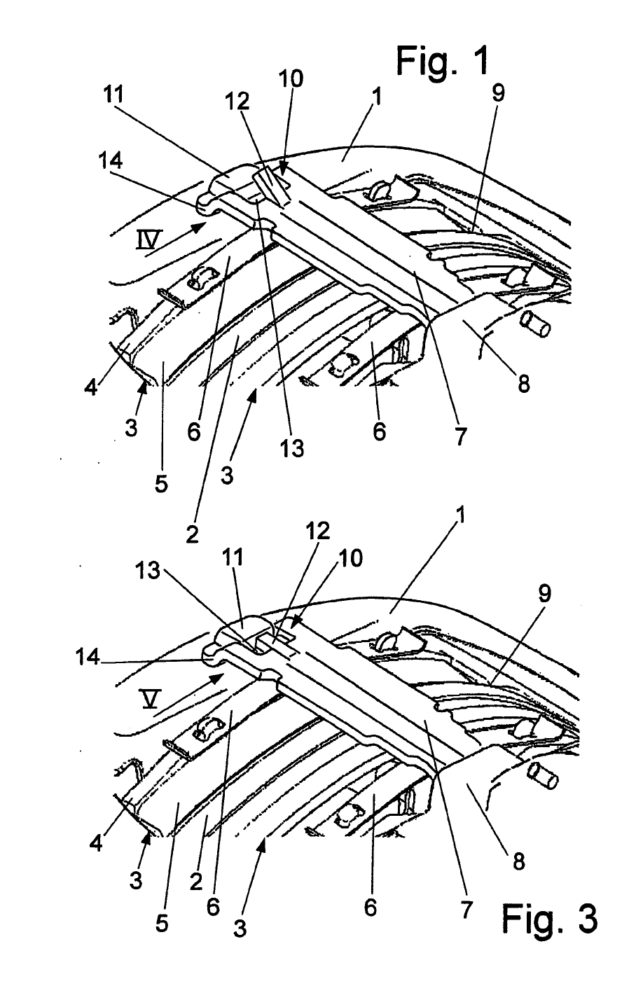

FIGS. 1 and 3 show a partial section of a disc brake, in particular for a commercial vehicle, with a caliper 1 extending around, i.e., straddling, a brake disc 2, in which caliper 1 are arranged brake pads 3 which contact the brake disc 2 during braking. Each brake pad 3 consists of a lining carrier plate 4 and a friction lining material 5 which is firmly connected to the lining carrier plate 4.

Pad retaining springs 6, each of which bears against the outer edge of the associated lining carrier plate 4, are provided for radially bracing the brake pads 3.

A holding bracket 7, which extends transversely to the direction of rotation of the brake disc 2 and bridges an assembly opening 9 of the caliper 1, bears against the pad retaining springs 6 in order to hold them down.

For fixing the holding bracket 7, a pocket-shaped receptacle 8, into which one end of the holding bracket 7 is inserted, is provided on one side of the caliper 1. The other end of the holding bracket 7 has a fastening element 10, which is a non-detachable part of the holding bracket 7, and which corresponds to an associated securing part 11 of the caliper 1 in the sense of a holding device.

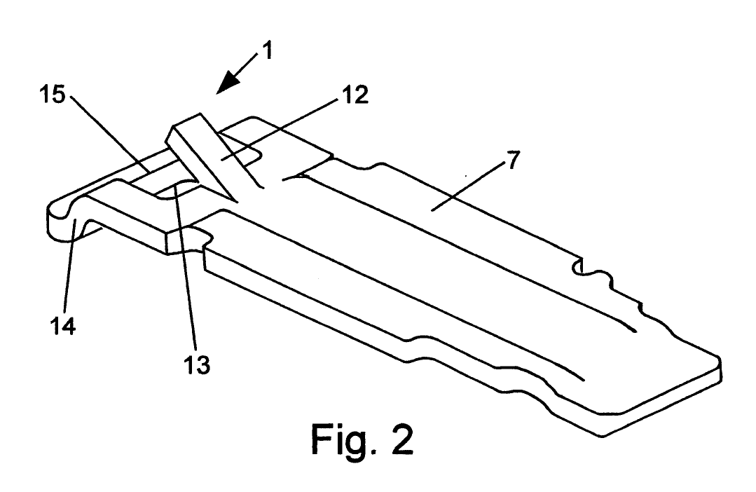

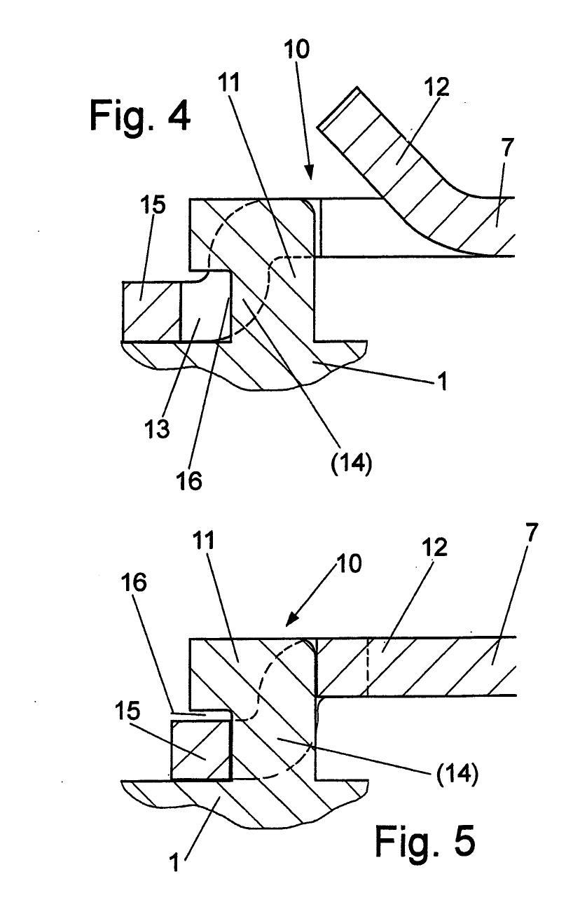

In the exemplary embodiment shown, a locking tab 12 formed integrally with the holding bracket 7 is provided as the fastening element 10 and, in the inoperative position shown in FIGS. 1, 2 and 4, is angled upwards with respect to the holding bracket 7 and the securing part 11.

In order to fasten the holding bracket 7, an end thereof is fitted onto the stool-shaped securing part 11, for which purpose the holding bracket 7 has a through-opening 13 which is delimited on the side opposite the locking tab 12 by a transverse web 15.

After being fitted in this manner, the holding bracket 7 is moved longitudinally in the direction of the receptacle 8, by which one of its ends is guided into the pocket-shaped receptacle 8, while the web 15 arranged at its other end is inserted into an undercut opening 16 of the securing part 11 until the web 15 comes into abutment therein. This position can be seen, in particular, in FIG. 1.

After this end position has been adopted, the locking tab 12 is bent in the direction of the securing part 11 and preferably caulked, the locking tab 12 projecting into the through-opening 13 and bearing with a frictional connection against an associated outer wall of the securing part 11. In this position, the web 15 located in the undercut opening 16 forms a bracing element, so that the holding bracket is firmly gripped in all directions. This position is shown especially clearly in FIGS. 3 and 5.

It can also be seen that the holding bracket 7 is provided in the region of the web with a stepped portion 14, which produces a level difference between the locking tab 12 in the operative position (FIGS. 3 and 5) and the web 15, the latter resting against the caliper 1 while the remainder of the holding bracket 7 is disposed at a distance from the caliper and bears against the pad retaining springs 6.

Table of References Symbols

| | |
|---|---|
| 1 | Caliper |
| 2 | Brake disc |
| 3 | Brake pad |
| 4 | Lining carrier plate |
| 5 | Friction lining material |
| 6 | Pad retaining spring |
| 7 | Holding bracket |
| 8 | Receptacle |
| 9 | Assembly opening |
| 10 | Fastening element |
| 11 | Securing part |
| 12 | Locking tab |
| 13 | Through-opening |
| 14 | Stepped portion |
| 15 | Web |
| 16 | Undercut opening |

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A disc brake having a brake disc, the disc brake comprising:
a caliper which, in use, straddles the brake disc;
brake pads pressable against the brake disc during braking;
a holding bracket fastened to the caliper and bearing against pad retaining springs acting on exterior edges of the brake pads;
wherein the holding bracket extends across an assembly opening of the caliper transverse to a rotational direction of the brake disc, the holding bracket being fastened at one end to the caliper in a form-fitting manner and being retained at another end via a fastening element;
wherein the fastening element is a non-detachable part of the holding bracket; and
wherein the caliper includes a securing part functioning as a holding device, the fastening element being operatively configured to correspond with the securing part.

2. The disc brake according to claim 1, wherein the fastening element comprises a locking tab, said locking tab bearing against the securing part to prevent displacement of the holding bracket when installed.

3. The disc brake according to claim 2, wherein the locking tab bears against the securing part with a frictional connection.

4. The disc brake according to claim 2, wherein the locking tab is integrally formed with the holding bracket.

5. The disc brake according to claim 3, wherein the locking tab is integrally formed with the holding bracket.

6. The disc brake according to claim 2, wherein the holding bracket and locking tab are a one-piece punched part.

7. The disc brake according to claim 4, wherein the holding bracket and locking tab are a one-piece punched part.

8. The disc brake according to claim 1, wherein the fastening element of the holding bracket includes a through-opening into which the securing part of the caliper extends.

9. The disc brake according to claim 2, wherein the fastening element of the holding bracket includes a through-opening into which the securing part of the caliper extends.

10. The disc brake according to claim 8, wherein prior to securing the holding bracket to the securing part, the locking tab is disposed at an angle upward relative to a side surface of the holding bracket facing away from the caliper when installed, the angled locking tab being bent into abutment with the securing part after the holding bracket is fitted onto the securing part.

11. The disc brake according to claim 9, wherein prior to securing the holding bracket to the securing part, the locking tab is disposed at an angle upward relative to a side surface of the holding bracket facing away from the caliper when installed, the angled locking tab being bent into abutment with the securing part after the holding bracket is fitted onto the securing part.

12. The disc brake according to claim 2, wherein the securing part includes an undercut on at least a side oriented away from the brake disc, a web of the fastening element engaging into the undercut when the holding bracket is installed.

13. The disc brake according to claim 12, wherein the web delimits at least a portion of the through-opening into which the securing part extends.

14. The disc brake according to claim 12, wherein via an abutment of the web against a wall of the undercut and via an abutment of the locking tab against the securing part, the holding bracket is clamped to the caliper.

15. The disc brake according to claim 12, wherein the holding bracket includes stepped portions between the web, which is disposed transversely to a longitudinal extension of the holding bracket, and a remainder of the holding bracket.

16. A component of a disc brake having a caliper which straddles a brake disc, the component comprising:
a holding bracket operatively configured to hold brake pads pressable against the brake disc in the caliper;
wherein the holding bracket has a longitudinal extent, at one end of which a fastening element is a non-detachable part of the holding bracket, said fastening element being operatively configured to correspond with an associated securing part of the caliper, the other end of the holding bracket including a tab operatively configured for insertion into a pocket of the caliper.

17. The holding bracket according to claim 16, wherein the fastening element comprises a through-opening delimited at an outer end of the holding bracket by a web extending transverse to the longitudinal extension of the holding bracket, and a locking tab aligned along the longitudinal extent of the holding bracket and extending into a portion of the through-opening; and
whereby the fastening element, when installed, has the web abutting the securing part of the caliper on one side and the locking tab abutting the securing part on the other side.
